(19) United States
(12) Patent Application Publication
(10) Pub. No.: US 2025/0048284 A1
(43) Pub. Date: Feb. 6, 2025

(54) TIMING ADVANCE GROUP INDICATION BASED ON UNIFIED TRANSMISSION CONFIGURATION INDICATION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Shaozhen GUO, Beijing (CN); Tao LUO, San Diego, CA (US); Xiaoxia ZHANG, San Diego, CA (US); Peter GAAL, San Diego, CA (US); Junyi LI, Greentown, PA (US)

(21) Appl. No.: 18/719,732

(22) PCT Filed: Feb. 9, 2022
(86) PCT No.: PCT/CN2022/075669

§ 371 Date: Jun. 13, 2024

(51) Int. Cl. H04W 56/00; H04W 76/38

(52) U.S. Cl. CPC H04W 56/0005; H04W 76/38

(57) ABSTRACT

Methods, systems, and devices for wireless communications are described. A user equipment (UE) may determine a timing advance value to use for an uplink transmission based on a unified transmission configuration indicator (TCI) state associated with the uplink transmission. In some examples, the control signaling configuring a unified TCI state for an uplink transmission may indicate the timing advance value for the uplink transmission. In some examples, the UE may receive control signaling indicating an association between a set of timing advance values for the component carrier associated with a set of unified TCI states or a set of unified TCI groups, and the UE may determine the timing advance value for a given uplink transmission based on the TCI state or TCI group indicated for the uplink transmission.

### CROSS REFERENCE

The present application is a 371 national stage filing of International PCT Application No. PCT/CN2022/075669 by YUAN et al. entitled “TIMING ADVANCE GROUP INDICATION BASED ON UNIFIED TRANSMISSION CONFIGURATION INDICATION,” filed Feb. 9, 2022, which is assigned to the assignee hereof, and which is expressly incorporated by reference in its entirety herein.

### FIELD OF TECHNOLOGY

The following relates to wireless communications, including timing advance group (TAG) indication based on unified transmission configuration indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities or one or more network access nodes, each simultaneously supporting communication for multiple communication devices, which may be otherwise known as user equipment (UE).

### SUMMARY

The described techniques relate to improved methods, systems, devices, and apparatuses that support timing advance group (TAG) indication based on unified transmission configuration indication. Generally, the described techniques provide for determining a timing advance value to use for an uplink transmission based on a unified transmission configuration indicator (TCI) state associated with the uplink transmission. In some examples, the control signaling configuring a unified TCI state for an uplink transmission may indicate the timing advance value for the uplink transmission. For example, a radio resource control (RRC) message may indicate a TAG identifier (ID) associated with the timing advance value. In some examples, a user equipment (UE) may receive control signaling indicating an association between a set of timing advance values for the component carrier associated with a set of unified TCI states or a set of unified TCI groups, and the UE may determine the timing advance value for a given uplink transmission based on the TCI state or TCI group indicated for the uplink transmission. The control signaling indicating the association between the set of timing advance values and the set of unified TCI states or the set of unified TCI group may be received via an RRC message or a medium access control (MAC) control element (MAC-CE).

A method for wireless communications is described. The method may include receiving a first control message indicating a timing advance configuration for a component carrier associated with a serving cell, the timing advance configuration indicating a set of timing advance values for communications via the component carrier, receiving a second control message indicating a unified TCI state for an uplink message via the component carrier, and transmitting the uplink message via the component carrier in accordance with the unified TCI state and a timing advance value from the set of timing advance values, the timing advance value based on the unified TCI state.

An apparatus for wireless communications is described. The apparatus may include a memory, and a processor coupled to the memory and configured to receive a first control message indicating a timing advance configuration for a component carrier associated with a serving cell, the timing advance configuration indicating a set of timing advance values for communications via the component carrier, receive a second control message indicating a unified TCI state for an uplink message via the component carrier, and transmit the uplink message via the component carrier in accordance with the unified TCI state and a timing advance value from the set of timing advance values, the timing advance value based on the unified TCI state.

Another apparatus for wireless communications is described. The apparatus may include means for receiving a first control message indicating a timing advance configuration for a component carrier associated with a serving cell, the timing advance configuration indicating a set of timing advance values for communications via the component carrier, means for receiving a second control message indicating a unified TCI state for an uplink message via the component carrier, and means for transmitting the uplink message via the component carrier in accordance with the unified TCI state and a timing advance value from the set of timing advance values, the timing advance value based on the unified TCI state.

A non-transitory computer-readable medium storing code for wireless communications is described. The code may include instructions executable by a processor to receive a first control message indicating a timing advance configuration for a component carrier associated with a serving cell, the timing advance configuration indicating a set of timing advance values for communications via the component carrier, receive a second control message indicating a unified TCI state for an uplink message via the component carrier, and transmit the uplink message via the component carrier in accordance with the unified TCI state and a timing advance value from the set of timing advance values, the timing advance value based on the unified TCI state.

Some examples of the method, apparatuses, and non-transitory computer-readable medium described herein may further include operations, features, means, or instructions for receiving a third control message indicating an association between a set of unified TCI states including the unified TCI state and the set of timing advance values, where the timing advance value may be identified based on the association between the unified TCI state and the timing advance value.

Some examples of the method, apparatuses, and non-transitory computer-readable medium described herein may further include operations, features, means, or instructions for receiving a third control message indicating an association between a set of unified TCI groups and the set of timing advance values, where a unified TCI group of the set of unified TCI groups includes the unified TCI state, where the timing advance value may be identified based on an association between the unified TCI group and the timing advance value.

In some examples of the method, apparatuses, and non-transitory computer-readable medium described herein, receiving the third control message may include operations, features, means, or instructions for receiving a bitmap indicating the association between the set of unified TCI groups and the set of timing advance values.

In some examples of the method, apparatuses, and non-transitory computer-readable medium described herein, receiving the second control message may include operations, features, means, or instructions for receiving an indication of the timing advance value for the uplink message in the second control message.

In some examples of the method, apparatuses, and non-transitory computer-readable medium described herein, receiving the indication of the timing advance value may include operations, features, means, or instructions for receiving a TAG ID that indicates the timing advance value.

In some examples of the method, apparatuses, and non-transitory computer-readable medium described herein, receiving the indication of the timing advance value may include operations, features, means, or instructions for receiving the indication of the timing advance value in an information element of an RRC message.

Some examples of the method, apparatuses, and non-transitory computer-readable medium described herein may further include operations, features, means, or instructions for receiving downlink control information indicating scheduling information for the uplink message, where the uplink message may be transmitted in accordance with the scheduling information.

In some examples of the method, apparatuses, and non-transitory computer-readable medium described herein, the first control message, the second control message, or both, includes an RRC message or a MAC-CE.

A method for wireless communications at a network device is described. The method may include transmitting, to a user equipment (UE), a first control message indicating a timing advance configuration for a component carrier associated with a serving cell configured by the network device, the timing advance configuration indicating a set of timing advance values for communications via the component carrier, transmitting, to the UE, a second control message indicating a unified TCI state for an uplink message via the component carrier, and receiving, from the UE, the uplink message on the component carrier in accordance with the unified TCI state and a timing advance value from the set of timing advance values, the timing advance value based on the unified TCI state.

An apparatus for wireless communications at a network device is described. The apparatus may include a memory, and a processor coupled to the memory and configured to transmit, to a UE, a first control message indicating a timing advance configuration for a component carrier associated with a serving cell configured by the network device, the timing advance configuration indicating a set of timing advance values for communications via the component carrier, transmit, to the UE, a second control message indicating a unified TCI state for an uplink message via the component carrier, and receive, from the UE, the uplink message on the component carrier in accordance with the unified TCI state and a timing advance value from the set of timing advance values, the timing advance value based on the unified TCI state.

Another apparatus for wireless communications at a network device is described. The apparatus may include means for transmitting, to a UE, a first control message indicating a timing advance configuration for a component carrier associated with a serving cell configured by the network device, the timing advance configuration indicating a set of timing advance values for communications via the component carrier, means for transmitting, to the UE, a second control message indicating a unified TCI state for an uplink message via the component carrier, and means for receiving, from the UE, the uplink message on the component carrier in accordance with the unified TCI state and a timing advance value from the set of timing advance values, the timing advance value based on the unified TCI state.

A non-transitory computer-readable medium storing code for wireless communications at a network device is described. The code may include instructions executable by a processor to transmit, to a UE, a first control message indicating a timing advance configuration for a component carrier associated with a serving cell configured by the network device, the timing advance configuration indicating a set of timing advance values for communications via the component carrier, transmit, to the UE, a second control message indicating a unified TCI state for an uplink message via the component carrier, and receive, from the UE, the uplink message on the component carrier in accordance with the unified TCI state and a timing advance value from the set of timing advance values, the timing advance value based on the unified TCI state.

Some examples of the method, apparatuses, and non-transitory computer-readable medium described herein may further include operations, features, means, or instructions for transmitting, to the UE, a third control message indicating an association between a set of unified TCI states including the unified TCI state and the set of timing advance values, where the timing advance value may be identified based on the association between the unified TCI state and the timing advance value.

Some examples of the method, apparatuses, and non-transitory computer-readable medium described herein may further include operations, features, means, or instructions for transmitting, to the UE, a third control message indicating an association between a set of unified TCI groups and the set of timing advance values, where a unified TCI group of the set of unified TCI groups includes the unified TCI state, where the timing advance value may be identified based on an association between the unified TCI group and the timing advance value.

In some examples of the method, apparatuses, and non-transitory computer-readable medium described herein, transmitting the third control message may include operations, features, means, or instructions for transmitting a bitmap indicating the association between the set of unified TCI groups and the set of timing advance values.

In some examples of the method, apparatuses, and non-transitory computer-readable medium described herein, transmitting the second control message may include operations, features, means, or instructions for transmitting an indication of the timing advance value for the uplink message in the second control message.

In some examples of the method, apparatuses, and non-transitory computer-readable medium described herein, transmitting the indication of the timing advance value may include operations, features, means, or instructions for transmitting a TAG ID that indicates the timing advance value.

In some examples of the method, apparatuses, and non-transitory computer-readable medium described herein, transmitting the indication of the timing advance value may include operations, features, means, or instructions for transmitting the indication of the timing advance value in an information element of an RRC message.

Some examples of the method, apparatuses, and non-transitory computer-readable medium described herein may further include operations, features, means, or instructions for transmitting, to the UE, downlink control information indicating scheduling information for the uplink message, where the uplink message may be transmitted in accordance with the scheduling information.

In some examples of the method, apparatuses, and non-transitory computer-readable medium described herein, the first control message, the second control message, or both, includes an RRC message or a MAC-CE.

### BRIEF DESCRIPTION OF THE DRAWINGS

FIG. 1 illustrates an example of a wireless communications system that supports timing advance group (TAG) indication based on unified transmission configuration indication in accordance with aspects of the present disclosure.

FIG. 2 illustrates an example of a wireless communications system that supports TAG indication based on unified transmission configuration indication in accordance with aspects of the present disclosure.

FIG. 3 illustrates an example of a timing diagram that supports TAG indication based on unified transmission configuration indication in accordance with aspects of the present disclosure.

FIG. 4 illustrates an example of a bitmap that supports TAG indication based on unified transmission configuration indication in accordance with aspects of the present disclosure.

FIG. 5 illustrates an example of a process flow that supports TAG indication based on unified transmission configuration indication in accordance with aspects of the present disclosure.

FIGS. 6 and 7 show block diagrams of devices that support TAG indication based on unified transmission configuration indication in accordance with aspects of the present disclosure.

FIG. 8 shows a block diagram of a communications manager that supports TAG indication based on unified transmission configuration indication in accordance with aspects of the present disclosure.

FIG. 9 shows a diagram of a system including a device that supports TAG indication based on unified transmission configuration indication in accordance with aspects of the present disclosure.

FIGS. 10 and 11 show block diagrams of devices that support TAG indication based on unified transmission configuration indication in accordance with aspects of the present disclosure.

FIG. 12 shows a block diagram of a communications manager that supports TAG indication based on unified transmission configuration indication in accordance with aspects of the present disclosure.

FIG. 13 shows a diagram of a system including a device that supports TAG indication based on unified transmission configuration indication in accordance with aspects of the present disclosure.

FIGS. 14 through 21 show flowcharts illustrating methods that support TAG indication based on unified transmission configuration indication in accordance with aspects of the present disclosure.

### DETAILED DESCRIPTION

In some wireless communications systems, a user equipment (UE) may be configured to receive downlink control information (DCI) from multiple transmission and reception points (TRPs) scheduling uplink transmissions (e.g., uplink reference signals or physical uplink shared channel (PUSCH) transmissions) to the multiple TRPs. A UE may receive an indication of a unified transmission configuration indicator (TCI) state for one or more signals. For example, a unified TCI type 1 may indicate a common beam for at least one downlink transmission and at least one uplink transmission, a unified TCI type 2 may indicate a common beam for more than one downlink transmissions, and a unified TCI type 3 may indicate a common beam for more than one uplink transmissions.

To increase the likelihood for successful communications between the UE and the multiple TRPs, the UE may adjust the timing of uplink transmissions from the UE such that uplink transmissions from the UE are received by each TRP aligned with a downlink frame at the TRP. The UE may adjust the timing of an uplink transmission to a TRP by applying a timing advance (e.g., a timing advance value) to the uplink transmission. The timing advance value that the UE may apply to uplink transmissions may be based on the receiving TRP. Some component carriers associated with a TRP (e.g., associated with a serving cell) may be associated with more than one timing advance value, which may indicate a timing offset for an uplink transmission. In some cases, only a single timing advance value may be indicated to the UE for a CC, so a UE may be uninformed of which timing advance of the multiple configured timing advance values to use for an uplink transmission on the component carrier.

A UE may determine the timing advance value to use for an uplink transmission based on a unified TCI state associated with the uplink transmission. In some examples, the control signaling (e.g., a radio resource control (RRC) message) configuring a unified TCI state for an uplink transmission may indicate the timing advance value for the uplink transmission. For example, the RRC message may indicate a timing advance group (TAG) identifier (ID) associated with the timing advance value and each TA may be associated with a respective TAG. In some examples, the UE may receive control signaling indicating an association between a set of timing advance values for the component carrier associated with a set of unified TCI states or a set of unified TCI groups, and the UE may determine the timing advance value for a given uplink transmission based on the TCI state or TCI group indicated for the uplink transmission. The control signaling indicating the association between the set of timing advance values and the set of unified TCI states or the set of unified TCI group may be received via an RRC message or a medium access control (MAC) control element (MAC-CE).

Aspects of the disclosure are initially described in the context of wireless communications systems. Aspects of the disclosure are further illustrated by and described with reference to timing diagrams, bitmaps, and process flows. Aspects of the disclosure are further illustrated by and described with reference to apparatus diagrams, system diagrams, and flowcharts that relate to TAG indication based on unified transmission configuration indication.

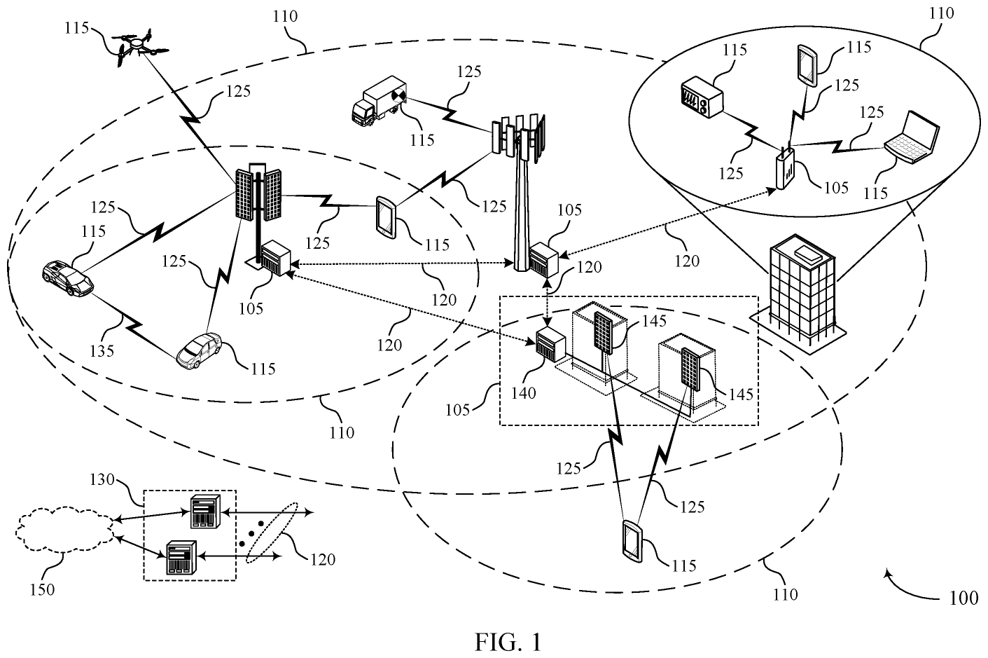

FIG. 1 illustrates an example of a wireless communications system 100 that supports TAG indication based on unified transmission configuration indication in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a core network 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a radio network entity, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay network entities, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an ID for distinguishing neighboring cells (e.g., a physical cell ID (PCID), a virtual cell ID (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may support synchronous or asynchronous operation. For synchronous operation, the network entities 105 may have similar frame timings, and transmissions from different network entities 105 may be approximately aligned in time. For asynchronous operation, the network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

Thus, as described herein, a network entity 105 may include one or more components that are located at a single physical location or one or more components located at various physical locations. In examples in which the network entity 105 includes components that are located at various physical locations, the various components may each perform various functions such that, collectively, the various components achieve functionality that is similar to a network entity 105 that is located at a single physical location. As such, a network entity 105 described herein may equivalently refer to a standalone network entity 105 (also known as a monolithic network entity) or a network entity 105 including components that are located at various physical locations or virtualized locations (also known as a disaggregated network entity). In some implementations, such a network entity 105 including components that are located at various physical locations may be referred to as or may be associated with a disaggregated radio access network (RAN) architecture, such as an Open RAN (O-RAN) or Virtualized RAN (VRAN) architecture. In some implementations, such components of a network entity 105 may include or refer to one or more of a central unit (or centralized unit CU), a distributed unit (DU), or a radio unit (RU).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Various types of unified TCI may be used for communications. For instance, a first type of unified TCI (e.g., Type 1 TCI) may be used to indicate a common beam for at least one downlink channel or reference signal and for at least one uplink channel or reference signal (e.g., a joint downlink uplink common TCI state). A second type of unified TCI (e.g., Type 2 TCI) may be used to indicate a common beam for more than one downlink channel or reference signal (e.g., a separate downlink common TCI state). A third type of unified TCI (e.g., Type 3 TCI) may be used to indicate a common beam for more than one uplink channel or reference signal (e.g., a separate uplink common TCI state). A fourth type of unified TCI (e.g., Type 4 TCI) may be used to indicate a beam for a single downlink channel or reference signal (e.g., a separate downlink single channel or reference signal TCI). A fifth type of unified TCI (e.g., Type 5 TCI) may be used to indicate a beam for a single uplink channel or reference signal (e.g., a separate uplink single channel or reference signal TCI). A sixth type of unified TCI (e.g., Type 6 TCI) may include uplink spatial relation information (SRI) to indicate a beam for a single uplink channel or reference signal. A seventh type of unified TCI may be a joint downlink/uplink common TCI state used to indicate a common beam for at least one downlink channel or reference signal and at least one uplink channel or reference signal. An eighth type of unified TCI may be a downlink common TCI state used to indicate a common beam for more than one downlink channel or reference signal. A ninth type of unified TCI may be an uplink common TCI state used to indicate a common beam for more than one uplink channel or reference signal.

In the wireless communications system 100, a UE 115 may be configured to receive DCI from multiple TRPs scheduling uplink transmissions (e.g., uplink reference signals or PUSCH transmissions) to the multiple TRPs. A UE 115 may receive an indication of a unified TCI state for one or more signals.

To increase the likelihood for successful communications between the UE 115 and the multiple TRPs, the UE 115 may adjust the timing of uplink transmissions from the UE 115 such that uplink transmissions from the UE 115 are received by each TRP aligned with a downlink frame at the TRP. The UE 115 may adjust the timing of an uplink transmission to a TRP by applying a timing advance (e.g., a timing advance value) to the uplink transmission. The timing advance value that the UE 115 may apply to uplink transmissions may be based on the receiving TRP. Some component carriers associated with a TRP (e.g., associated with a serving cell) may be associated with more than one timing advance value, which may indicate a timing offset for an uplink transmission.

A UE 115 may determine the timing advance value to use for an uplink transmission on a component carrier based on a unified TCI state associated with the uplink transmission. In some examples, the control signaling (e.g., an RRC message) configuring a unified TCI state for an uplink transmission may indicate the timing advance value for the uplink transmission. For example, the RRC message may indicate a TAG ID associated with the timing advance value. In some examples, the UE 115 may receive control signaling indicating an association between a set of timing advance values for the component carrier associated with a set of unified TCI states or a set of unified TCI groups, and the UE 115 may determine the timing advance value for a given uplink transmission based on the TCI state or TCI group indicated for the uplink transmission. The control signaling indicating the association between the set of timing advance values and the set of unified TCI states or the set of unified TCI group may be received via an RRC message or a MAC-CE.

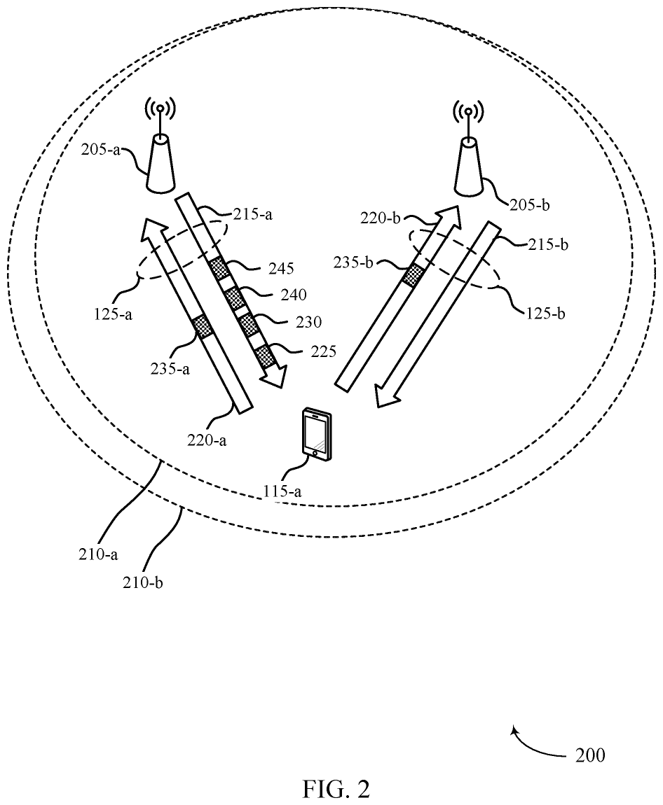

FIG. 2 illustrates an example of a wireless communications system 200 that supports TAG indication based on unified transmission configuration indication in accordance with aspects of the present disclosure. In some examples, the wireless communications system 200 may implement aspects of wireless communications system 100. The wireless communications system 200 may include a UE 115 a which may be an example of a UE 115 as described herein.

The wireless communications system 200 (for example, high frequency systems such as 5G/NR systems), may support combining multiple carriers into a single data channel on a serving cell to increase the data capacity of the network. In some cases, a devices such as a UE 115-a may be configured to use a downlink carrier that is associated with two or more uplink carriers 210-a and 210-b in a serving cell.

The wireless communications system 200 may further support multi-DCI, multi-TRP operation to reduce signaling overhead and increase throughput. For example, the UE 115-a may operate in a multiple TRP mode with TRPs 205-a and 205-b. For instance, UE 115-a may be capable of performing simultaneous communication with TRPs 205-a and TRP 205-b. The UE 115-a may communicate with the TRP 205-a using a communication link 125-a. The UE 115-a may communicate with the TRP 205-b using a communication link 125-b. The communication link 125-a and the communication link 125-b may include bi-directional links that enable both uplink and downlink communication. For example, the communication link 125-a may include a downlink communication link 215-a and an uplink communication link 220-a, and the communication link 125-b may include a downlink communication link 215-b and an uplink communication link 220-b. For example, the UE 115-a may transmit uplink signals, such as uplink control signals or uplink data signals, to the TRP 205-a using the uplink communication link 220-a and to the TRP 205-b using the uplink communication link 220-b. The TRP 205-a may transmit downlink transmissions, such as downlink control signals or downlink data signals, to the UE 115-a using the downlink communication link 215-a, and the TRP 205-b may transmit downlink transmissions, such as downlink control signals or downlink data signals, to the UE 115-a using the downlink communication link 215-b. In some examples, different TRPs (e.g., TRP 205-a and TRP 205-b) may have different TRP IDs. In some examples, different TRPs may be identified through an association with other IDs, such as a CORESET pool index, close loop index, TCI ID, TCI group ID, or a sounding reference signal resource set ID.

In some examples, the UE 115-a may communicate with TRP 205-a and TRP 205-b using frequencies allocated for the corresponding uplink and downlink carriers configured for the UE 115-a. In some examples, the UE 115-a may communicate uplink messages 235-a and 235-b (e.g., simultaneously, concurrently) using the corresponding uplink carriers 210-a and 210-b.

In some examples, the network may configure the UE 115-a to transmit the uplink communications using different timing advance values, in which the UE 115-a may adjust the timing in which the UE 115-a sends uplink communications so that the uplink transmissions are synchronized when received by the network. In some examples, two or more timing advance values may be configured for a component carrier 210-a or 210-b. For example, a timing advance configuration may include a TAG ID and each component carrier may be configured with two or more TAG IDs, and the timing advance value may be associated with a TAG which may be updated by timing advance commands for the TAG. The UE 115-a may determine the timing advance to use for an uplink message 235-a or 235-b from the two or more timing advances configured for the component carrier 210-a or 210-b.

For example, the UE 115-a may receive, from the TRP 205-a, a first control message 225 indicating a timing advance configuration for a component carrier 210-a associated with a serving cell, the timing advance configuration indicating a set of timing advance values for communications via the component carrier 210-a. In some examples, the first control message 225 may be received via an RRC message or a MAC-CE.

The UE 115-a may also receive, from the TRP 205-a, a second control message 230 indicating a unified TCI state for the uplink message 235-a via the component carrier 210-a. In some examples, the second control message 230 may be received via an RRC message or a MAC-CE.

The UE 115-a may determine a timing advance from the set of timing advance values for the uplink message 235-a for transmission via the component carrier 210-a based on the indicated unified TCI state. The UE 115-a may transmit the uplink message 235-a via the component carrier 210-a in accordance with the unified TCI state and the determined timing advance of the set of timing advances.

In some examples, the UE 115-a may receive, from the TRP 205-a, a third control message 240 indicating an association between a set of unified TCI states including the unified TCI state and the set of timing advance values, and the timing advance value may be identified based on the association between the unified TCI state and the timing advance value. For example, if the UE 115-a is configured with multiple timing advances or TAGs, for a component carrier 210-a, and is also configured with a list of TCI states (e.g., via the second control message 230), the timing advance or TAG indication may be associated with a TCI state of the list of TCI states by a third control message 240 (e.g., via an RRC message or via a MAC-CE). For example, an RRC message may indicate, for each timing advance or TAG configured for the serving cell associated with the component carrier 210-a, an associated unified TCI group. In some examples, TCIs in a list of TCI states may be grouped based on an explicit signaling, or TCIs in a list of TCI states may be grouped based on an implicit rule. As an example of an implicit rule, different TCI groups may have TCIs of source reference signal(s) from different set of SSBs. As another example, an RRC message may indicate, for each TCI or for each TCI group configured for the serving cell associated with the component carrier 210-a, an associated timing advance value (or a TAG ID). Accordingly, the UE 115-a may determine the timing advance from the set of timing advances for the component carrier 210-a based on the indicated TCI state for the uplink message 235-a in the second control message 230.

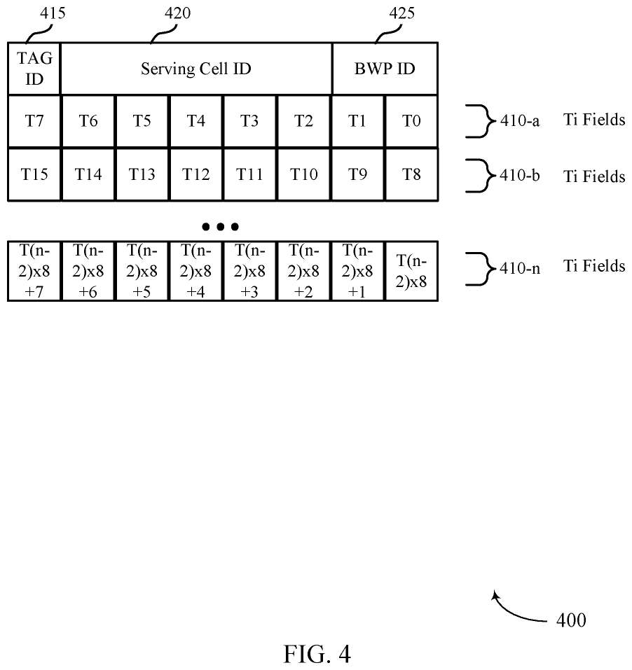

In some examples, the third control message 240 may be transmitted via a MAC-CE. For example, a TCI group may be specified by a MAC-CE. In some examples, the MAC-CE indicating the TCI group may include an indication of a timing advance value or a TAG, for example as described with reference to FIG. 4. For example, the MAC-CE may include a bitmap indicating the association between a TCI group and a timing advance value or a TAG. For example, if a TAG ID field in the MAC-CE is TAGID-0, then the first TAG configured to the component carrier 210-a will be applied to the uplink message 235-a. If a TAG ID field in the MAC-CE is TAGID=1, then the second TAG configured to the component carrier 210-a will be applied to the uplink message 235-a. Ti values in the MAC-CE bitmap may indicate which TCI states below to the unified TCI group associated with the timing advance value or TAG. For example, if a Ti field Ti=0, then the ith TCI state is not applied to the indicated timing advance value or TAG, and if the Ti=1, then the ith TCI state is applied to the indicated timing advance value or TAG. In some examples, the indication of the association may be an indication per TAG without TAG IDs. For example, if the Ti=0, then the ith TCI may be associated with a first timing advance value or TAG, and if the Ti=1, then the ith TCI may be associated with a second timing advance value or TAG.

In some examples, the second control message 230 includes an indication of the timing advance value for the uplink message in the second control message. In some examples, the indication of the timing advance value includes a TAG ID that indicates the timing advance value. In some examples, the indication of the timing advance value for the uplink message 235-a is received via an information element of an RRC message.

In some examples, the UE 115-a may receive, from the TRP 205-a, a DCI message 245 indicating scheduling information for the uplink message 235-a, and the UE 115-a transmits the uplink message 235 in accordance with the scheduling information, the indicated unified, TCI state, and the determined timing advance.

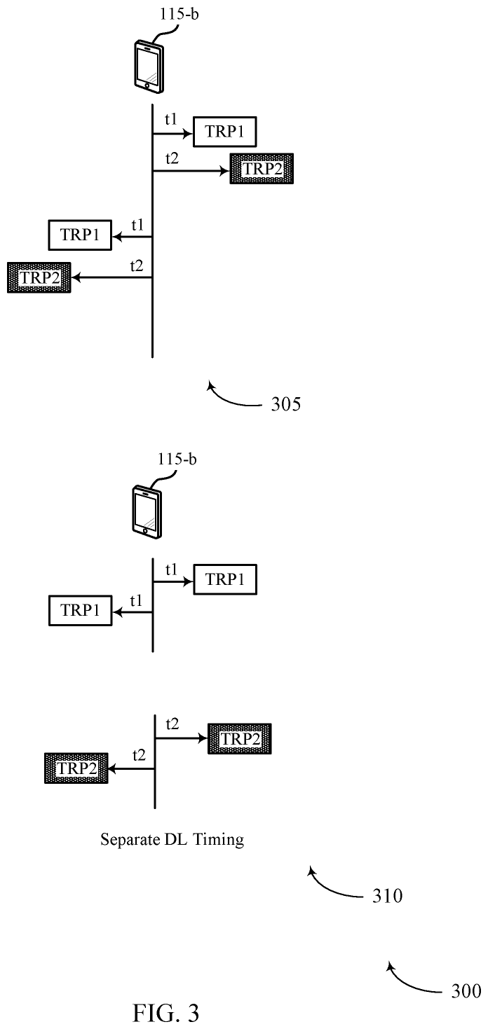

FIG. 3 illustrates an example of a timing diagram 300 that supports TAG indication based on unified transmission configuration indication in accordance with aspects of the present disclosure. In some examples, the timing diagram 300 may implement aspects of wireless communications system 100 or wireless communications system 200. For instance, TRPs 205-a and 205-b may each be an example of a network entity 105 as described with reference to FIG. 1. Additionally or alternatively, the wireless communications system 200 may include a UE 115-b which may be an example of a UE 115 as described herein.

In some examples, as shown in the multi-TRP deployment 305, a UE 115-b may be configured for multi-TRP multi-DCI operations. In some examples, single downlink timing may be applied for a multi-TRP deployment, where a first timing advance value (e.g., t1) is applied for communications between the UE 115-b and a first TRP (e.g., TRP1) jointly with a second timing advance value (e.g., t2) that is applied for communications between the UE 115-b and a second TRP (e.g., TRP 2).

In some examples, as shown in the multi-TRP deployment 310, separate downlink timing may be applied for a multi-TRP deployment, where a first timing advance value (e.g., t1) is applied for communications between the UE 115-b and TRP 1, and a second timing advance value (e.g., t2) is applied for communications between the UE 115-b and TRP2.

FIG. 4 illustrates an example of a bitmap 400 that supports TAG indication based on unified transmission configuration indication in accordance with aspects of the present disclosure. In some examples, the bitmap 400 may implement aspects of wireless communications system 100 or wireless communications system 200.

For example, as association between a timing advance value or a TAG and a unified TCI group may be indicated via a bitmap 400. The bitmap may be transmitted, for example, to a UE 115 via a MAC-CE. The bitmap 400 may include a TAG ID field 415, a serving cell ID field 420 (indicating a serving cell associated with the bitmap 400), and a bandwidth part ID field 425 (indicating a bandwidth par associated with the bitmap 400).

The bitmap may include rows 410-a, 410-b, through 410-n including Ti cells associated with respective unified TCI states. In some examples, if a given Ti field is set to 1, then the unified TCI state is associated with the respective TAG indicated in the TAG ID field 415. If a given Ti field is set to 0, then the unified TCI state is no associated with the respective TAG indicated in the TAG ID field 415. Accordingly, the bitmap may indicate, for the serving cell and bandwidth part identified by the serving cell ID 420 and the bandwidth part ID field 425, a unifier TCI group associated with the TAG indicated by the TAG ID field 415.

In some examples, the bitmap may not include a TAG ID field 415. For example, the TCI states associated with Ti fields set to “0” may be associated with a first TAG, and the Ti fields set to “1” may be associated with a second TAG.

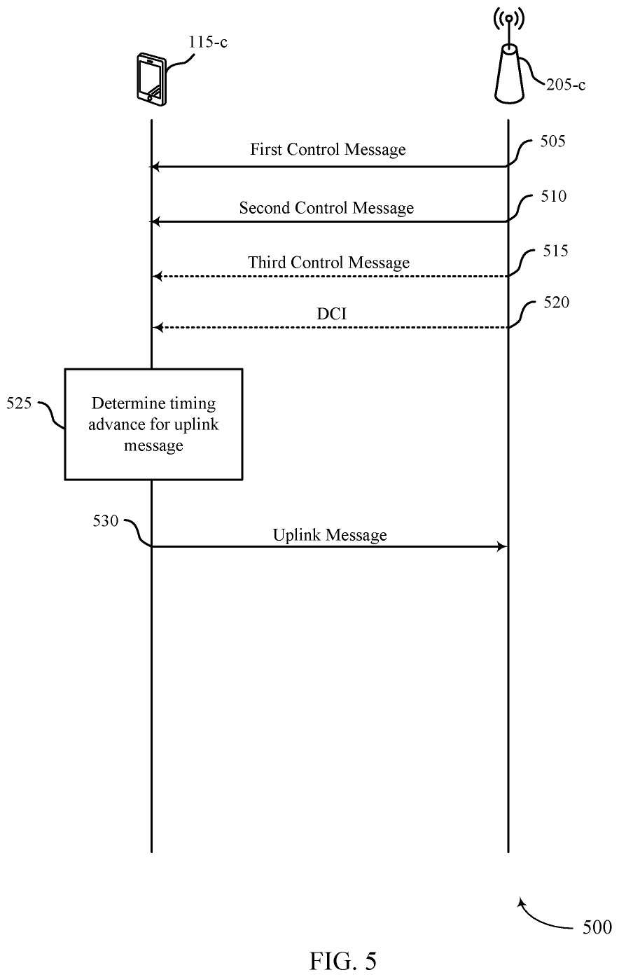

FIG. 5 illustrates an example of a process flow 500 that supports TAG indication based on unified transmission configuration indication in accordance with aspects of the present disclosure. The process flow 500 may include a UE 115-c, which may be an example of a UE 115 as described herein. The process flow 500 may include a TRP 205-c, which may be an example of a TRP 205 as described herein. In the following description of the process flow 500, the operations between the TRP 205-c and the UE 115-c may be transmitted in a different order than the example order shown, or the operations performed by the TRP 205-c and the UE 115-c may be performed in different orders or at different times. Some operations may also be omitted from the process flow 500, and other operations may be added to the process flow 500.

At 505, the UE 115-c may receive, from the TRP 205-c, a first control message indicating a timing advance configuration for a component carrier associated with a serving cell, the timing advance configuration indicating a set of timing advance values for communications via the component carrier. In some examples, the first control message may be received via an RRC message or a MAC-CE.

At 510, the UE 115-c may receive, from the TRP 205-c, a second control message indicating a unified TCI state for an uplink message via the component carrier. In some examples, the second control message may be received via an RRC message or a MAC-CE.

At 525, the UE 115-c may determine a timing advance from the set of timing advance values for an uplink message for transmission via the component carrier based on the unified TCI state.

At 530, the UE 115-c may transmit the uplink message via the component carrier in accordance with the unified TCI state and the determined timing advance of the set of timing advances.

In some examples, at 515, the UE 115-c may receive, from the TRP 205-c, a third control message indicating an association between a set of unified TCI states including the unified TCI state and the set of timing advance values, where the timing advance value is identified based on the association between the unified TCI state and the timing advance value. In some examples, the third control message may indicate an association between a set of unified TCI groups and the set of timing advance values, where a unified TCI group of the set of unified TCI groups includes the unified TCI state, where the timing advance value is identified based on an association between the unified TCI group and the timing advance value. In some examples, the third control message includes a bitmap indicating the association between the set of unified TCI groups and the set of timing advance values.

In some examples, the second control message received at 510 includes an indication of the timing advance value for the uplink message in the second control message. In some examples, the indication of the timing advance value includes a TAG ID that indicates the timing advance value. In some examples, the indication of the timing advance value for the uplink message is received via an information element of an RRC message.

In some examples, at 520, the UE 115-c may receive, from the TRP 205-c, DCI indicating scheduling information for the uplink message, and at 530 the uplink message is transmitted in accordance with the scheduling information.

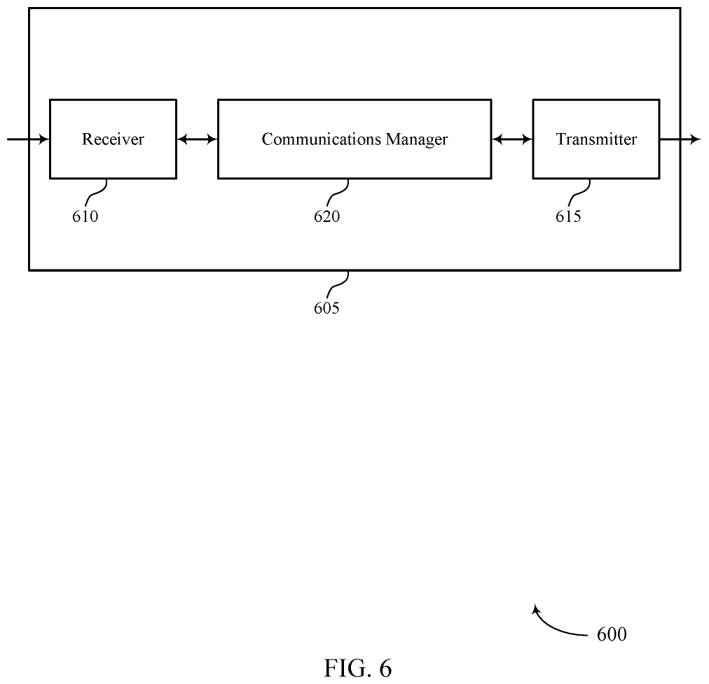

FIG. 6 shows a block diagram 600 of a device 605 that supports TAG indication based on unified transmission configuration indication in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to TAG indication based on unified transmission configuration indication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to TAG indication based on unified transmission configuration indication). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of TAG indication based on unified transmission configuration indication as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications in accordance with examples as disclosed herein. For example, the communications manager 620 may be configured as or otherwise support a means for receiving a first control message indicating a timing advance configuration for a component carrier associated with a serving cell, the timing advance configuration indicating a set of timing advance values for communications via the component carrier. The communications manager 620 may be configured as or otherwise support a means for receiving a second control message indicating a unified TCI state for an uplink message via the component carrier. The communications manager 620 may be configured as or otherwise support a means for transmitting the uplink message via the component carrier in accordance with the unified TCI state and a timing advance value from the set of timing advance values, the timing advance value based on the unified TCI state.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, more efficient utilization of communication resources, increased throughput, and enhanced uplink performance by enabling a timing advance indication based on a unified TCI state.

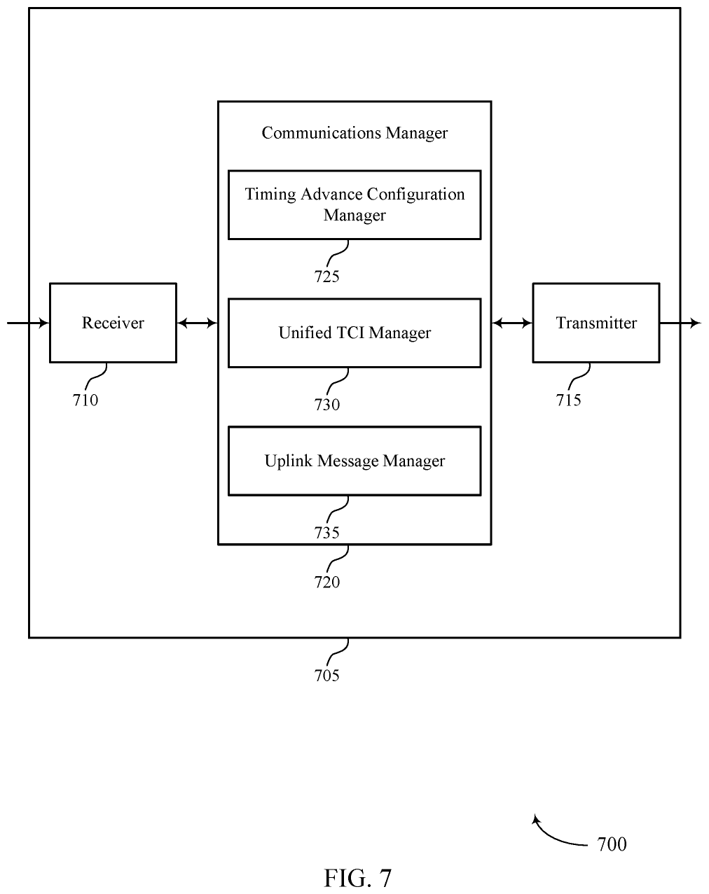

FIG. 7 shows a block diagram 700 of a device 705 that supports TAG indication based on unified transmission configuration indication in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to TAG indication based on unified transmission configuration indication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to TAG indication based on unified transmission configuration indication). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of TAG indication based on unified transmission configuration indication as described herein. For example, the communications manager 720 may include a timing advance configuration manager 725, a unified TCI manager 730, an uplink message manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications in accordance with examples as disclosed herein. The timing advance configuration manager 725 may be configured as or otherwise support a means for receiving a first control message indicating a timing advance configuration for a component carrier associated with a serving cell, the timing advance configuration indicating a set of timing advance values for communications via the component carrier. The unified TCI manager 730 may be configured as or otherwise support a means for receiving a second control message indicating a unified TCI state for an uplink message via the component carrier. The uplink message manager 735 may be configured as or otherwise support a means for transmitting the uplink message via the component carrier in accordance with the unified TCI state and a timing advance value from the set of timing advance values, the timing advance value based on the unified TCI state.

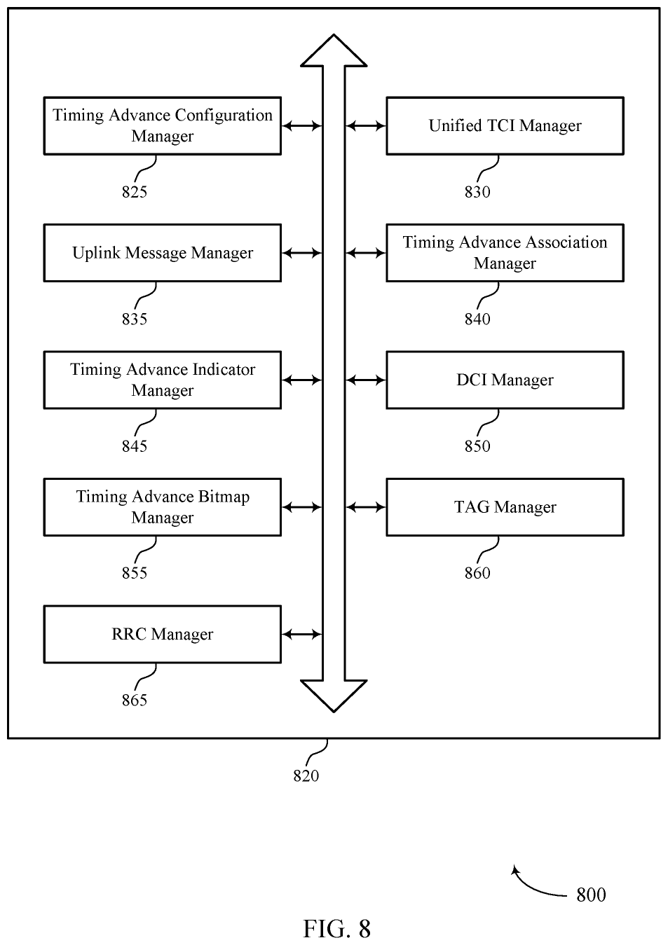

FIG. 8 shows a block diagram 800 of a communications manager 820 that supports TAG indication based on unified transmission configuration indication in accordance with aspects of the present disclosure. The communications manager 820 may be an example of aspects of a communications manager 620, a communications manager 720, or both, as described herein. The communications manager 820, or various components thereof, may be an example of means for performing various aspects of TAG indication based on unified transmission configuration indication as described herein. For example, the communications manager 820 may include a timing advance configuration manager 825, a unified TCI manager 830, an uplink message manager 835, a timing advance association manager 840, a timing advance indicator manager 845, a DCI manager 850, a timing advance bitmap manager 855, a TAG (TAG) manager 860, an RRC manager 865, or any combination thereof. Each of these components may communicate, directly or indirectly, with one another (e.g., via one or more buses).

The communications manager 820 may support wireless communications in accordance with examples as disclosed herein. The timing advance configuration manager 825 may be configured as or otherwise support a means for receiving a first control message indicating a timing advance configuration for a component carrier associated with a serving cell, the timing advance configuration indicating a set of timing advance values for communications via the component carrier. The unified TCI manager 830 may be configured as or otherwise support a means for receiving a second control message indicating a unified TCI state for an uplink message via the component carrier. The uplink message manager 835 may be configured as or otherwise support a means for transmitting the uplink message via the component carrier in accordance with the unified TCI state and a timing advance value from the set of timing advance values, the timing advance value based on the unified TCI state.

In some examples, the timing advance association manager 840 may be configured as or otherwise support a means for receiving a third control message indicating an association between a set of unified TCI states including the unified TCI state and the set of timing advance values, where the timing advance value is identified based on the association between the unified TCI state and the timing advance value.

In some examples, the timing advance association manager 840 may be configured as or otherwise support a means for receiving a third control message indicating an association between a set of unified TCI groups and the set of timing advance values, where a unified TCI group of the set of unified TCI groups includes the unified TCI state, where the timing advance value is identified based on an association between the unified TCI group and the timing advance value.

In some examples, to support receiving the third control message, the timing advance bitmap manager 855 may be configured as or otherwise support a means for receiving a bitmap indicating the association between the set of unified TCI groups and the set of timing advance values.

In some examples, to support receiving the second control message, the timing advance indicator manager 845 may be configured as or otherwise support a means for receiving an indication of the timing advance value for the uplink message in the second control message.

In some examples, to support receiving the indication of the timing advance value, the TAG manager 860 may be configured as or otherwise support a means for receiving a TAG ID that indicates the timing advance value.

In some examples, to support receiving the indication of the timing advance value, the RRC manager 865 may be configured as or otherwise support a means for receiving the indication of the timing advance value in an information element of an RRC message.

In some examples, the DCI manager 850 may be configured as or otherwise support a means for receiving downlink control information indicating scheduling information for the uplink message, where the uplink message is transmitted in accordance with the scheduling information.

In some examples, the first control message, the second control message, or both, includes an RRC message or a MAC-CE.

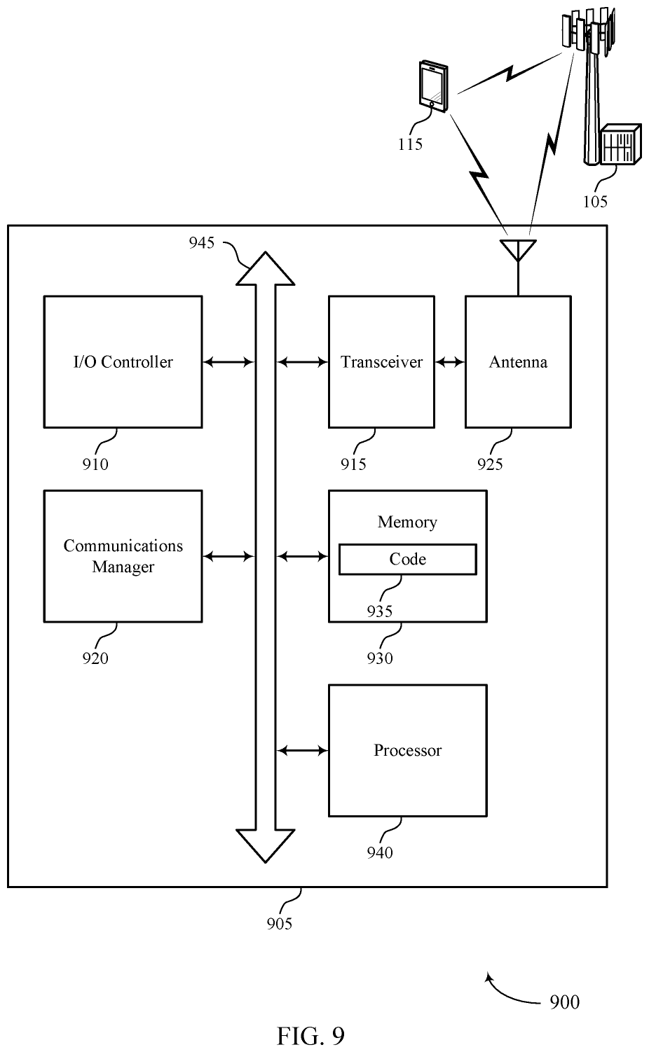

FIG. 9 shows a diagram of a system 900 including a device 905 that supports TAG indication based on unified transmission configuration indication in accordance with aspects of the present disclosure. The device 905 may be an example of or include the components of a device 605, a device 705, or a UE 115 as described herein. The device 905 may communicate wirelessly with one or more network entities 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting TAG indication based on unified transmission configuration indication). For example, the device 905 or a component of the device 905 may include a processor 940 and memory 930 coupled with or to the processor 940, the processor 940 and memory 930 configured to perform various functions described herein.

The communications manager 920 may support wireless communications in accordance with examples as disclosed herein. For example, the communications manager 920 may be configured as or otherwise support a means for receiving a first control message indicating a timing advance configuration for a component carrier associated with a serving cell, the timing advance configuration indicating a set of timing advance values for communications via the component carrier. The communications manager 920 may be configured as or otherwise support a means for receiving a second control message indicating a unified TCI state for an uplink message via the component carrier. The communications manager 920 may be configured as or otherwise support a means for transmitting the uplink message via the component carrier in accordance with the unified TCI state and a timing advance value from the set of timing advance values, the timing advance value based on the unified TCI state.

By including or configuring the communications manager 920 in accordance with examples as described herein, the device 905 may support techniques for improved communication reliability, reduced latency, improved user experience based on increased throughput, more efficient utilization of communication resources, improved coordination and synchronization between devices, and increased uplink coverage and performance by enabling a timing advance indication based on a unified TCI state.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of TAG indication based on unified transmission configuration indication as described herein, or the processor 940 and the memory 930 may be otherwise configured to perform or support such operations.

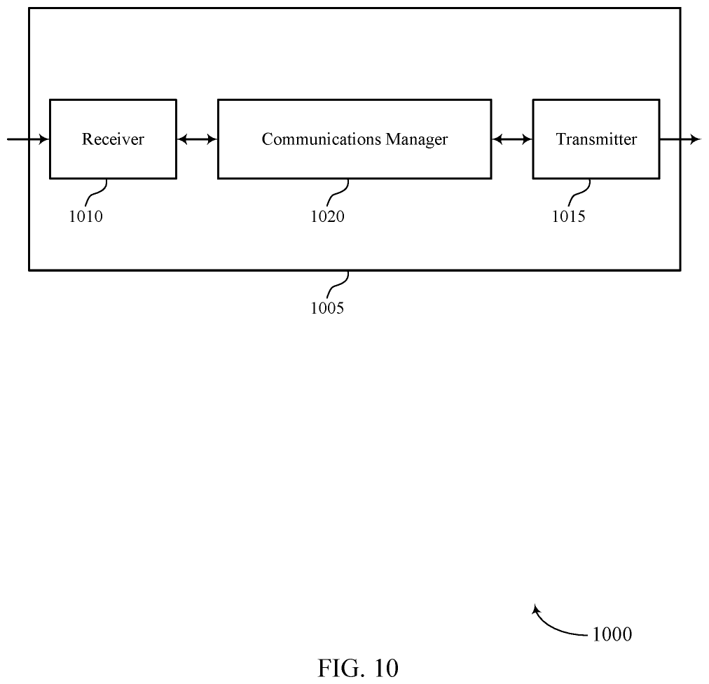

FIG. 10 shows a block diagram 1000 of a device 1005 that supports TAG indication based on unified transmission configuration indication in accordance with aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to TAG indication based on unified transmission configuration indication). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to TAG indication based on unified transmission configuration indication). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of TAG indication based on unified transmission configuration indication as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a network device in accordance with examples as disclosed herein. For example, the communications manager 1020 may be configured as or otherwise support a means for transmitting, to a UE, a first control message indicating a timing advance configuration for a component carrier associated with a serving cell configured by the network device, the timing advance configuration indicating a set of timing advance values for communications via the component carrier. The communications manager 1020 may be configured as or otherwise support a means for transmitting, to the UE, a second control message indicating a unified TCI state for an uplink message via the component carrier. The communications manager 1020 may be configured as or otherwise support a means for receiving, from the UE, the uplink message on the component carrier in accordance with the unified TCI state and a timing advance value from the set of timing advance values, the timing advance value based on the unified TCI state.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, more efficient utilization of communication resources, increased throughput, and enhanced uplink performance by enabling a timing advance indication based on a unified TCI state.

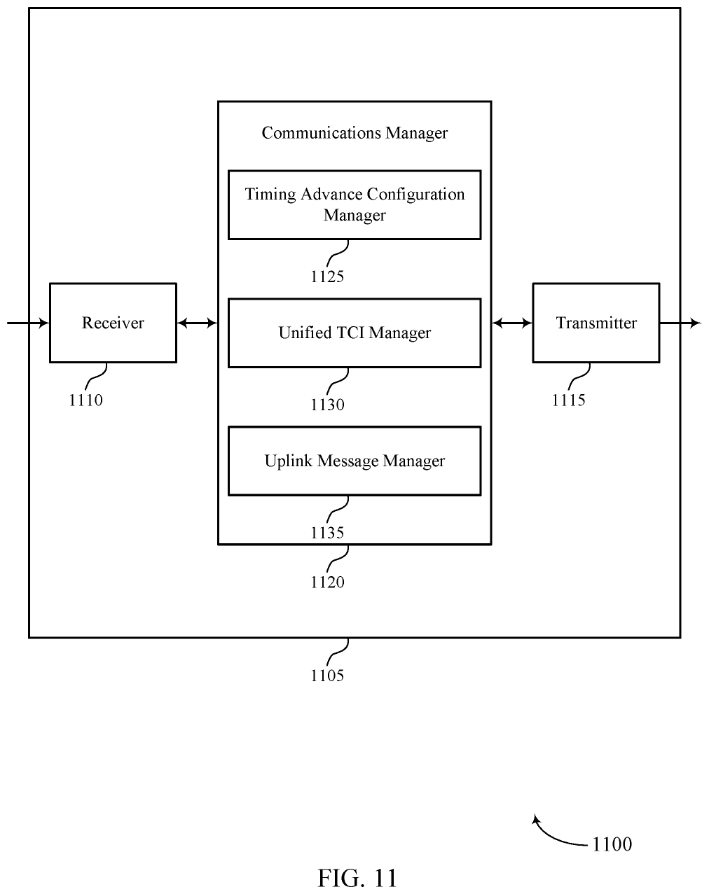

FIG. 11 shows a block diagram 1100 of a device 1105 that supports TAG indication based on unified transmission configuration indication in accordance with aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to TAG indication based on unified transmission configuration indication). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to TAG indication based on unified transmission configuration indication). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of TAG indication based on unified transmission configuration indication as described herein. For example, the communications manager 1120 may include a timing advance configuration manager 1125, a unified TCI manager 1130, an uplink message manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a network device in accordance with examples as disclosed herein. The timing advance configuration manager 1125 may be configured as or otherwise support a means for transmitting, to a UE, a first control message indicating a timing advance configuration for a component carrier associated with a serving cell configured by the network device, the timing advance configuration indicating a set of timing advance values for communications via the component carrier. The unified TCI manager 1130 may be configured as or otherwise support a means for transmitting, to the UE, a second control message indicating a unified TCI state for an uplink message via the component carrier. The uplink message manager 1135 may be configured as or otherwise support a means for receiving, from the UE, the uplink message on the component carrier in accordance with the unified TCI state and a timing advance value from the set of timing advance values, the timing advance value based on the unified TCI state.

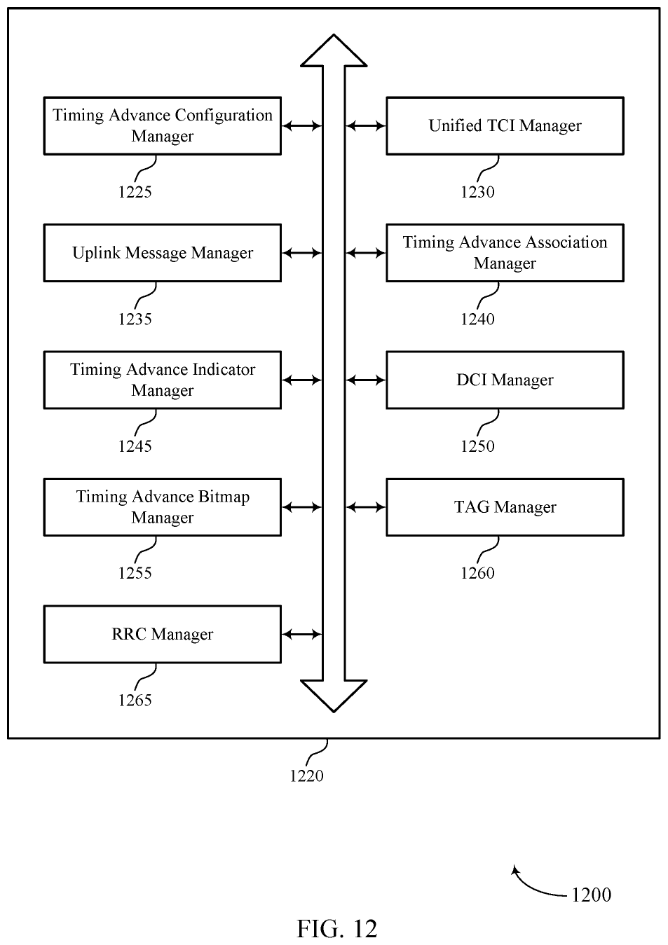

FIG. 12 shows a block diagram 1200 of a communications manager 1220 that supports TAG indication based on unified transmission configuration indication in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of TAG indication based on unified transmission configuration indication as described herein. For example, the communications manager 1220 may include a timing advance configuration manager 1225, a unified TCI manager 1230, an uplink message manager 1235, a timing advance association manager 1240, a timing advance indicator manager 1245, a DCI manager 1250, a timing advance bitmap manager 1255, a TAG manager 1260, an RRC manager 1265, or any combination thereof. Each of these components may communicate, directly or indirectly, with one another (e.g., via one or more buses).

The communications manager 1220 may support wireless communications at a network device in accordance with examples as disclosed herein. The timing advance configuration manager 1225 may be configured as or otherwise support a means for transmitting, to a UE, a first control message indicating a timing advance configuration for a component carrier associated with a serving cell configured by the network device, the timing advance configuration indicating a set of timing advance values for communications via the component carrier. The unified TCI manager 1230 may be configured as or otherwise support a means for transmitting, to the UE, a second control message indicating a unified TCI state for an uplink message via the component carrier. The uplink message manager 1235 may be configured as or otherwise support a means for receiving, from the UE, the uplink message on the component carrier in accordance with the unified TCI state and a timing advance value from the set of timing advance values, the timing advance value based on the unified TCI state.

In some examples, the timing advance association manager 1240 may be configured as or otherwise support a means for transmitting, to the UE, a third control message indicating an association between a set of unified TCI states including the unified TCI state and the set of timing advance values, where the timing advance value is identified based on the association between the unified TCI state and the timing advance value.

In some examples, the timing advance association manager 1240 may be configured as or otherwise support a means for transmitting, to the UE, a third control message indicating an association between a set of unified TCI groups and the set of timing advance values, where a unified TCI group of the set of unified TCI groups includes the unified TCI state, where the timing advance value is identified based on an association between the unified TCI group and the timing advance value.

In some examples, to support transmitting the third control message, the timing advance bitmap manager 1255 may be configured as or otherwise support a means for transmitting a bitmap indicating the association between the set of unified TCI groups and the set of timing advance values.

In some examples, to support transmitting the second control message, the timing advance indicator manager 1245 may be configured as or otherwise support a means for transmitting an indication of the timing advance value for the uplink message in the second control message.

In some examples, to support transmitting the indication of the timing advance value, the TAG manager 1260 may be configured as or otherwise support a means for transmitting a TAG ID that indicates the timing advance value.

In some examples, to support transmitting the indication of the timing advance value, the RRC manager 1265 may be configured as or otherwise support a means for transmitting the indication of the timing advance value in an information element of an RRC message.

In some examples, the DCI manager 1250 may be configured as or otherwise support a means for transmitting, to the UE, downlink control information indicating scheduling information for the uplink message, where the uplink message is transmitted in accordance with the scheduling information.

In some examples, the first control message, the second control message, or both, includes an RRC message or a MAC-CE.

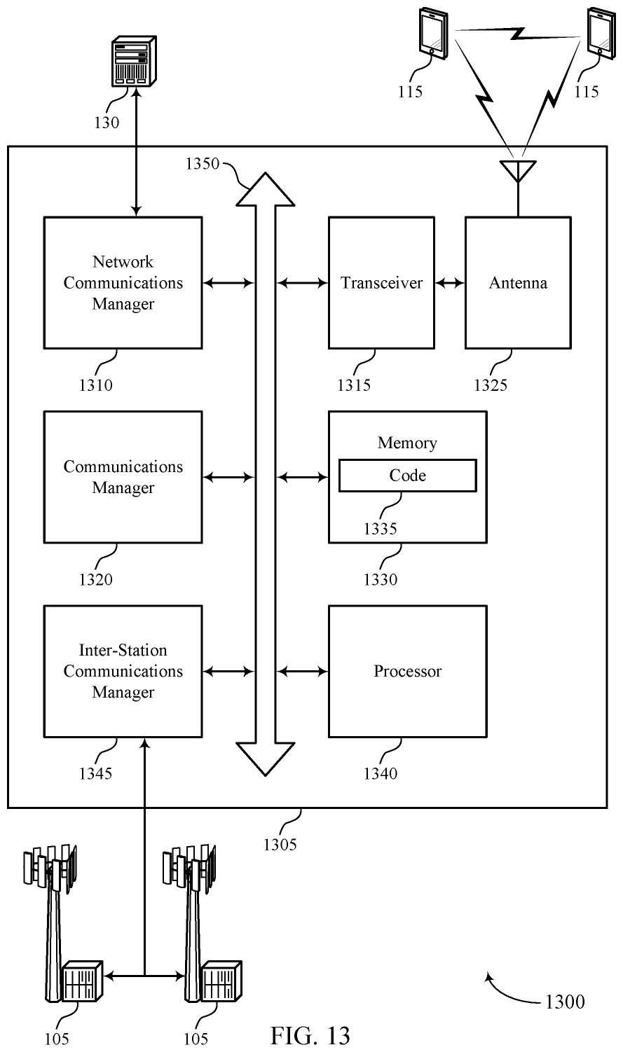

FIG. 13 shows a diagram of a system 1300 including a device 1305 that supports TAG indication based on unified transmission configuration indication in accordance with aspects of the present disclosure. The device 1305 may be an example of or include the components of a device 1005, a device 1105, or a network entity 105 as described herein. The device 1305 may communicate wirelessly with one or more network entities 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting TAG indication based on unified transmission configuration indication). For example, the device 1305 or a component of the device 1305 may include a processor 1340 and memory 1330 coupled with or to the processor 1340, the processor 1340 and memory 1330 configured to perform various functions described herein.

The inter-station communications manager 1345 may manage communications with other network entities 105, and may include a controller or scheduler for controlling communications with UEs 115 in cooperation with other network entities 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between network entities 105.

The communications manager 1320 may support wireless communications at a network device in accordance with examples as disclosed herein. For example, the communications manager 1320 may be configured as or otherwise support a means for transmitting, to a UE, a first control message indicating a timing advance configuration for a component carrier associated with a serving cell configured by the network device, the timing advance configuration indicating a set of timing advance values for communications via the component carrier. The communications manager 1320 may be configured as or otherwise support a means for transmitting, to the UE, a second control message indicating a unified TCI state for an uplink message via the component carrier. The communications manager 1320 may be configured as or otherwise support a means for receiving, from the UE, the uplink message on the component carrier in accordance with the unified TCI state and a timing advance value from the set of timing advance values, the timing advance value based on the unified TCI state.

By including or configuring the communications manager 1320 in accordance with examples as described herein, the device 1305 may support techniques for improved communication reliability, reduced latency, improved user experience based on increased throughput, more efficient utilization of communication resources, improved coordination and synchronization between devices, and increased uplink coverage and performance by enabling a timing advance indication based on a unified TCI state.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of TAG indication based on unified transmission configuration indication as described herein, or the processor 1340 and the memory 1330 may be otherwise configured to perform or support such operations.

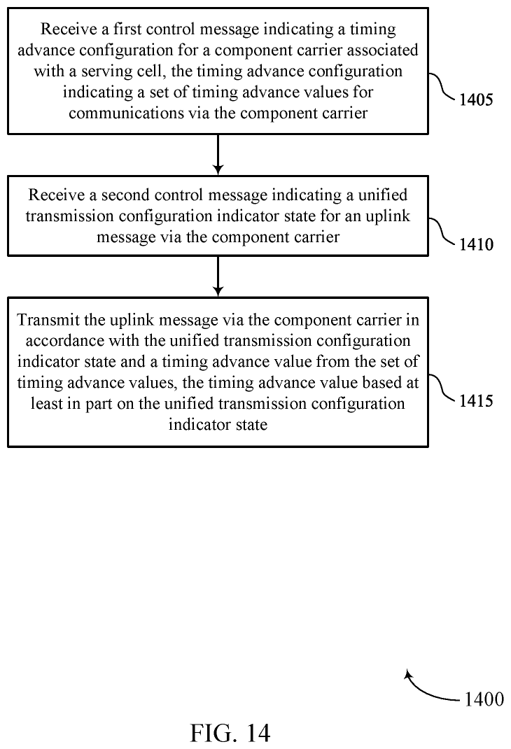

FIG. 14 shows a flowchart illustrating a method 1400 that supports TAG indication based on unified transmission configuration indication in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving a first control message indicating a timing advance configuration for a component carrier associated with a serving cell, the timing advance configuration indicating a set of timing advance values for communications via the component carrier. The operations of 1405 may be performed in accordance with examples as disclosed herein. In some examples, aspects of the operations of 1405 may be performed by a timing advance configuration manager 825 as described with reference to FIG. 8.

At 1410, the method may include receiving a second control message indicating a unified TCI state for an uplink message via the component carrier. The operations of 1410 may be performed in accordance with examples as disclosed herein. In some examples, aspects of the operations of 1410 may be performed by a unified TCI manager 830 as described with reference to FIG. 8.

At 1415, the method may include transmitting the uplink message via the component carrier in accordance with the unified TCI state and a timing advance value from the set of timing advance values, the timing advance value based on the unified TCI state. The operations of 1415 may be performed in accordance with examples as disclosed herein. In some examples, aspects of the operations of 1415 may be performed by an uplink message manager 835 as described with reference to FIG. 8.

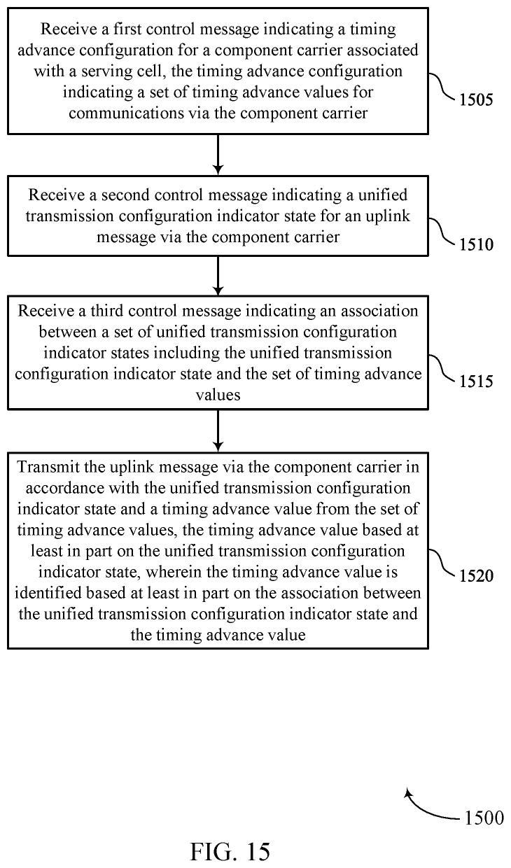

FIG. 15 shows a flowchart illustrating a method 1500 that supports TAG indication based on unified transmission configuration indication in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving a first control message indicating a timing advance configuration for a component carrier associated with a serving cell, the timing advance configuration indicating a set of timing advance values for communications via the component carrier. The operations of 1505 may be performed in accordance with examples as disclosed herein. In some examples, aspects of the operations of 1505 may be performed by a timing advance configuration manager 825 as described with reference to FIG. 8.

At 1510, the method may include receiving a second control message indicating a unified TCI state for an uplink message via the component carrier. The operations of 1510 may be performed in accordance with examples as disclosed herein. In some examples, aspects of the operations of 1510 may be performed by a unified TCI manager 830 as described with reference to FIG. 8.

At 1515, the method may include receiving a third control message indicating an association between a set of unified TCI states including the unified TCI state and the set of timing advance values. The operations of 1515 may be performed in accordance with examples as disclosed herein. In some examples, aspects of the operations of 1515 may be performed by a timing advance association manager 840 as described with reference to FIG. 8.

At 1520, the method may include transmitting the uplink message via the component carrier in accordance with the unified TCI state and a timing advance value from the set of timing advance values, the timing advance value based on the unified TCI state, where the timing advance value is identified based on the association between the unified TCI state and the timing advance value. The operations of 1520 may be performed in accordance with examples as disclosed herein. In some examples, aspects of the operations of 1520 may be performed by an uplink message manager 835 as described with reference to FIG. 8.

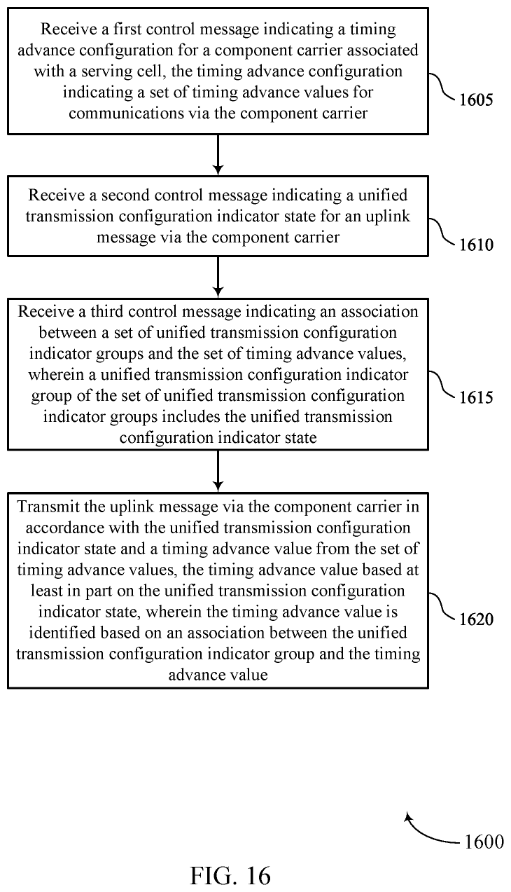

FIG. 16 shows a flowchart illustrating a method 1600 that supports TAG indication based on unified transmission configuration indication in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving a first control message indicating a timing advance configuration for a component carrier associated with a serving cell, the timing advance configuration indicating a set of timing advance values for communications via the component carrier. The operations of 1605 may be performed in accordance with examples as disclosed herein. In some examples, aspects of the operations of 1605 may be performed by a timing advance configuration manager 825 as described with reference to FIG. 8.

At 1610, the method may include receiving a second control message indicating a unified TCI state for an uplink message via the component carrier. The operations of 1610 may be performed in accordance with examples as disclosed herein. In some examples, aspects of the operations of 1610 may be performed by a unified TCI manager 830 as described with reference to FIG. 8.

At 1615, the method may include receiving a third control message indicating an association between a set of unified TCI groups and the set of timing advance values, where a unified TCI group of the set of unified TCI groups includes the unified TCI state. The operations of 1615 may be performed in accordance with examples as disclosed herein. In some examples, aspects of the operations of 1615 may be performed by a timing advance association manager 840 as described with reference to FIG. 8.

At 1620, the method may include transmitting the uplink message via the component carrier in accordance with the unified TCI state and a timing advance value from the set of timing advance values, the timing advance value based on the unified TCI state, where the timing advance value is identified based on an association between the unified TCI group and the timing advance value. The operations of 1620 may be performed in accordance with examples as disclosed herein. In some examples, aspects of the operations of 1620 may be performed by an uplink message manager 835 as described with reference to FIG. 8.

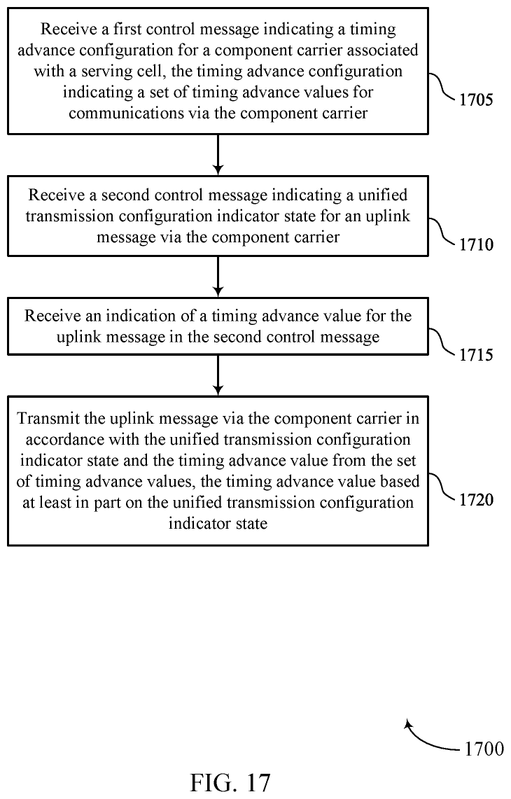

FIG. 17 shows a flowchart illustrating a method 1700 that supports TAG indication based on unified transmission configuration indication in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include receiving a first control message indicating a timing advance configuration for a component carrier associated with a serving cell, the timing advance configuration indicating a set of timing advance values for communications via the component carrier. The operations of 1705 may be performed in accordance with examples as disclosed herein. In some examples, aspects of the operations of 1705 may be performed by a timing advance configuration manager 825 as described with reference to FIG. 8.

At 1710, the method may include receiving a second control message indicating a unified TCI state for an uplink message via the component carrier. The operations of 1710 may be performed in accordance with examples as disclosed herein. In some examples, aspects of the operations of 1710 may be performed by a unified TCI manager 830 as described with reference to FIG. 8.

At 1715, the method may include receiving an indication of the timing advance value for the uplink message in the second control message. The operations of 1715 may be performed in accordance with examples as disclosed herein. In some examples, aspects of the operations of 1715 may be performed by a timing advance indicator manager 845 as described with reference to FIG. 8.

At 1720, the method may include transmitting the uplink message via the component carrier in accordance with the unified TCI state and a timing advance value from the set of timing advance values, the timing advance value based on the unified TCI state. The operations of 1720 may be performed in accordance with examples as disclosed herein. In some examples, aspects of the operations of 1720 may be performed by an uplink message manager 835 as described with reference to FIG. 8.

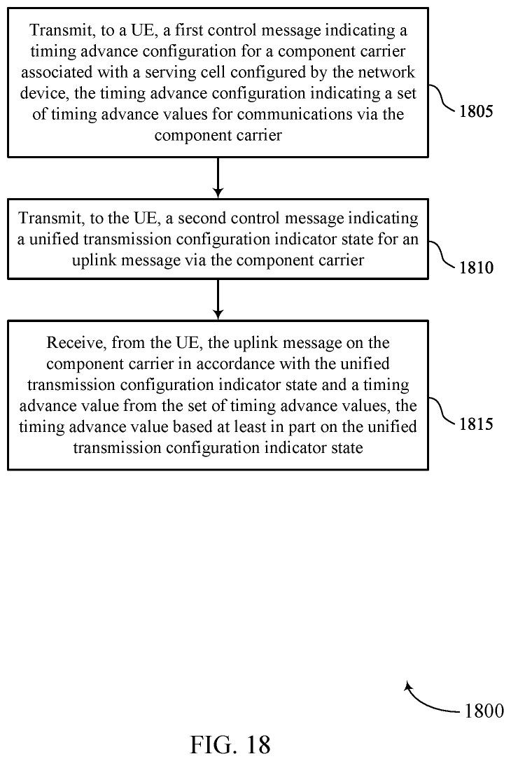

FIG. 18 shows a flowchart illustrating a method 1800 that supports TAG indication based on unified transmission configuration indication in accordance with aspects of the present disclosure. The operations of the method 1800 may be implemented by a network entity or its components as described herein. For example, the operations of the method 1800 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1805, the method may include transmitting, to a UE, a first control message indicating a timing advance configuration for a component carrier associated with a serving cell configured by the network device, the timing advance configuration indicating a set of timing advance values for communications via the component carrier. The operations of 1805 may be performed in accordance with examples as disclosed herein. In some examples, aspects of the operations of 1805 may be performed by a timing advance configuration manager 1225 as described with reference to FIG. 12.

At 1810, the method may include transmitting, to the UE, a second control message indicating a unified TCI state for an uplink message via the component carrier. The operations of 1810 may be performed in accordance with examples as disclosed herein. In some examples, aspects of the operations of 1810 may be performed by a unified TCI manager 1230 as described with reference to FIG. 12.

At 1815, the method may include receiving, from the UE, the uplink message on the component carrier in accordance with the unified TCI state and a timing advance value from the set of timing advance values, the timing advance value based on the unified TCI state. The operations of 1815 may be performed in accordance with examples as disclosed herein. In some examples, aspects of the operations of 1815 may be performed by an uplink message manager 1235 as described with reference to FIG. 12.

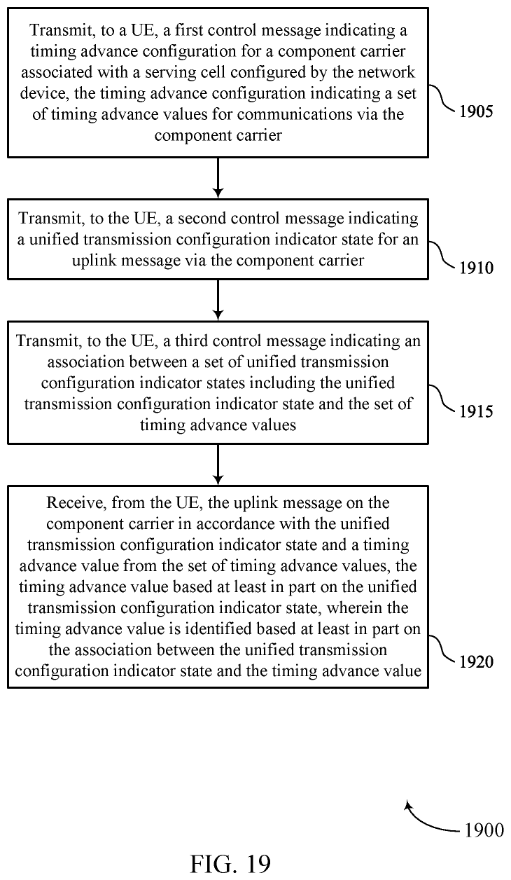

FIG. 19 shows a flowchart illustrating a method 1900 that supports TAG indication based on unified transmission configuration indication in accordance with aspects of the present disclosure. The operations of the method 1900 may be implemented by a network entity or its components as described herein. For example, the operations of the method 1900 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1905, the method may include transmitting, to a UE, a first control message indicating a timing advance configuration for a component carrier associated with a serving cell configured by the network device, the timing advance configuration indicating a set of timing advance values for communications via the component carrier. The operations of 1905 may be performed in accordance with examples as disclosed herein. In some examples, aspects of the operations of 1905 may be performed by a timing advance configuration manager 1225 as described with reference to FIG. 12.

At 1910, the method may include transmitting, to the UE, a second control message indicating a unified TCI state for an uplink message via the component carrier. The operations of 1910 may be performed in accordance with examples as disclosed herein. In some examples, aspects of the operations of 1910 may be performed by a unified TCI manager 1230 as described with reference to FIG. 12.

At 1915, the method may include transmitting, to the UE, a third control message indicating an association between a set of unified TCI states including the unified TCI state and the set of timing advance values. The operations of 1915 may be performed in accordance with examples as disclosed herein. In some examples, aspects of the operations of 1915 may be performed by a timing advance association manager 1240 as described with reference to FIG. 12.

At 1920, the method may include receiving, from the UE, the uplink message on the component carrier in accordance with the unified TCI state and a timing advance value from the set of timing advance values, the timing advance value based on the unified TCI state, where the timing advance value is identified based on the association between the unified TCI state and the timing advance value. The operations of 1920 may be performed in accordance with examples as disclosed herein. In some examples, aspects of the operations of 1920 may be performed by an uplink message manager 1235 as described with reference to FIG. 12.

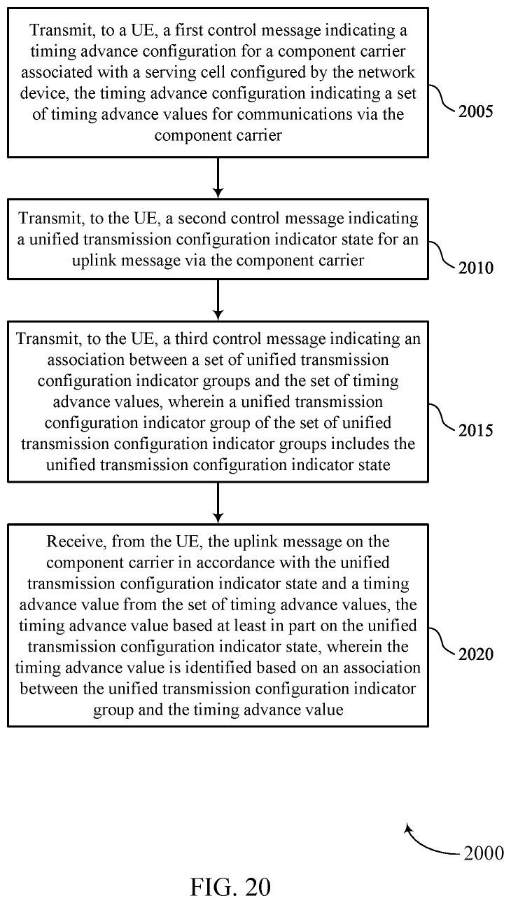

FIG. 20 shows a flowchart illustrating a method 2000 that supports TAG indication based on unified transmission configuration indication in accordance with aspects of the present disclosure. The operations of the method 2000 may be implemented by a network entity or its components as described herein. For example, the operations of the method 2000 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 2005, the method may include transmitting, to a UE, a first control message indicating a timing advance configuration for a component carrier associated with a serving cell configured by the network device, the timing advance configuration indicating a set of timing advance values for communications via the component carrier. The operations of 2005 may be performed in accordance with examples as disclosed herein. In some examples, aspects of the operations of 2005 may be performed by a timing advance configuration manager 1225 as described with reference to FIG. 12.

At 2010, the method may include transmitting, to the UE, a second control message indicating a unified TCI state for an uplink message via the component carrier. The operations of 2010 may be performed in accordance with examples as disclosed herein. In some examples, aspects of the operations of 2010 may be performed by a unified TCI manager 1230 as described with reference to FIG. 12.

At 2015, the method may include transmitting, to the UE, a third control message indicating an association between a set of unified TCI groups and the set of timing advance values, where a unified TCI group of the set of unified TCI groups includes the unified TCI state. The operations of 2015 may be performed in accordance with examples as disclosed herein. In some examples, aspects of the operations of 2015 may be performed by a timing advance association manager 1240 as described with reference to FIG. 12.

At 2020, the method may include receiving, from the UE, the uplink message on the component carrier in accordance with the unified TCI state and a timing advance value from the set of timing advance values, the timing advance value based on the unified TCI state, where the timing advance value is identified based on an association between the unified TCI group and the timing advance value. The operations of 2020 may be performed in accordance with examples as disclosed herein. In some examples, aspects of the operations of 2020 may be performed by an uplink message manager 1235 as described with reference to FIG. 12.

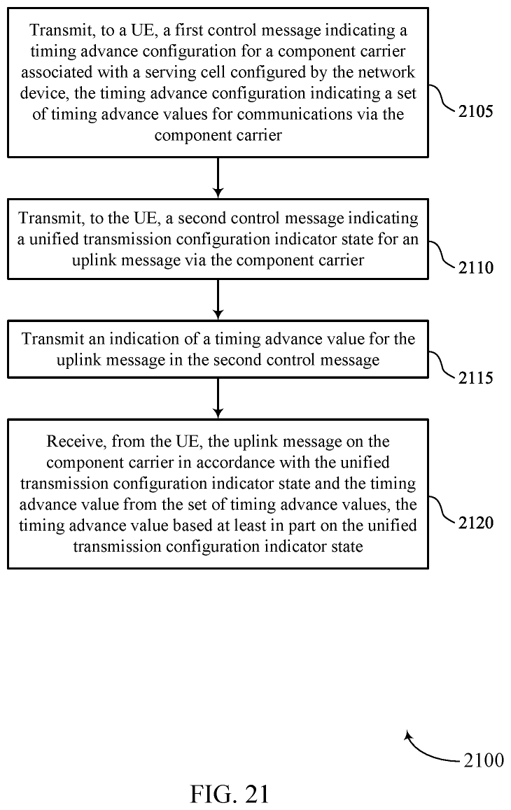

FIG. 21 shows a flowchart illustrating a method 2100 that supports TAG indication based on unified transmission configuration indication in accordance with aspects of the present disclosure. The operations of the method 2100 may be implemented by a network entity or its components as described herein. For example, the operations of the method 2100 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 2105, the method may include transmitting, to a UE, a first control message indicating a timing advance configuration for a component carrier associated with a serving cell configured by the network device, the timing advance configuration indicating a set of timing advance values for communications via the component carrier. The operations of 2105 may be performed in accordance with examples as disclosed herein. In some examples, aspects of the operations of 2105 may be performed by a timing advance configuration manager 1225 as described with reference to FIG. 12.

At 2110, the method may include transmitting, to the UE, a second control message indicating a unified TCI state for an uplink message via the component carrier. The operations of 2110 may be performed in accordance with examples as disclosed herein. In some examples, aspects of the operations of 2110 may be performed by a unified TCI manager 1230 as described with reference to FIG. 12.

At 2115, the method may include transmitting an indication of the timing advance value for the uplink message in the second control message. The operations of 2115 may be performed in accordance with examples as disclosed herein. In some examples, aspects of the operations of 2115 may be performed by a timing advance indicator manager 1245 as described with reference to FIG. 12.

At 2120, the method may include receiving, from the UE, the uplink message on the component carrier in accordance with the unified TCI state and a timing advance value from the set of timing advance values, the timing advance value based on the unified TCI state. The operations of 2120 may be performed in accordance with examples as disclosed herein. In some examples, aspects of the operations of 2120 may be performed by an uplink message manager 1235 as described with reference to FIG. 12.

The following provides an overview of aspects of the present disclosure:

Aspect 1: A method for wireless communications, comprising: receiving a first control message indicating a timing advance configuration for a component carrier associated with a serving cell, the timing advance configuration indicating a set of timing advance values for communications via the component carrier; receiving a second control message indicating a unified transmission configuration indicator state for an uplink message via the component carrier; and transmitting the uplink message via the component carrier in accordance with the unified transmission configuration indicator state and a timing advance value from the set of timing advance values, the timing advance value based at least in part on the unified transmission configuration indicator state.

Aspect 2: The method of aspect 1, further comprising: receiving a third control message indicating an association between a set of unified transmission configuration indicator states including the unified transmission configuration indicator state and the set of timing advance values, wherein the timing advance value is identified based at least in part on the association between the unified transmission configuration indicator state and the timing advance value.

Aspect 3: The method of any of aspects 1 through 2, further comprising: receiving a third control message indicating an association between a set of unified transmission configuration indicator groups and the set of timing advance values, wherein a unified transmission configuration indicator group of the set of unified transmission configuration indicator groups includes the unified transmission configuration indicator state, wherein the timing advance value is identified based on an association between the unified transmission configuration indicator group and the timing advance value.

Aspect 4: The method of aspect 3, wherein receiving the third control message comprises: receiving a bitmap indicating the association between the set of unified transmission configuration indicator groups and the set of timing advance values.

Aspect 5: The method of any of aspects 1 through 4, wherein receiving the second control message comprises: receiving an indication of the timing advance value for the uplink message in the second control message.

Aspect 6: The method of aspect 5, wherein receiving the indication of the timing advance value comprises: receiving a timing advance group identifier that indicates the timing advance value.

Aspect 7: The method of any of aspects 5 through 6, wherein receiving the indication of the timing advance value comprises: receiving the indication of the timing advance value in an information element of a radio resource control message.

Aspect 8: The method of any of aspects 1 through 7, further comprising: receiving downlink control information indicating scheduling information for the uplink message, wherein the uplink message is transmitted in accordance with the scheduling information.

Aspect 9: The method of any of aspects 1 through 8, wherein the first control message, the second control message, or both, comprises a radio resource control message or a medium access control (MAC) control element (MAC-CE).

Aspect 10: A method for wireless communications at a network device, comprising: transmitting, to a UE, a first control message indicating a timing advance configuration for a component carrier associated with a serving cell configured by the network device, the timing advance configuration indicating a set of timing advance values for communications via the component carrier; transmitting, to the UE, a second control message indicating a unified transmission configuration indicator state for an uplink message via the component carrier; and receiving, from the UE, the uplink message on the component carrier in accordance with the unified transmission configuration indicator state and a timing advance value from the set of timing advance values, the timing advance value based at least in part on the unified transmission configuration indicator state.

Aspect 11: The method of aspect 10, further comprising: transmitting, to the UE, a third control message indicating an association between a set of unified transmission configuration indicator states including the unified transmission configuration indicator state and the set of timing advance values, wherein the timing advance value is identified based at least in part on the association between the unified transmission configuration indicator state and the timing advance value.

Aspect 12: The method of any of aspects 10 through 11, further comprising: transmitting, to the UE, a third control message indicating an association between a set of unified transmission configuration indicator groups and the set of timing advance values, wherein a unified transmission configuration indicator group of the set of unified transmission configuration indicator groups includes the unified transmission configuration indicator state, wherein the timing advance value is identified based on an association between the unified transmission configuration indicator group and the timing advance value.

Aspect 13: The method of aspect 12, wherein transmitting the third control message comprises: transmitting a bitmap indicating the association between the set of unified transmission configuration indicator groups and the set of timing advance values.

Aspect 14: The method of any of aspects 10 through 13, wherein transmitting the second control message comprises: transmitting an indication of the timing advance value for the uplink message in the second control message.

Aspect 15: The method of aspect 14, wherein transmitting the indication of the timing advance value comprises: transmitting a timing advance group identifier that indicates the timing advance value.

Aspect 16: The method of any of aspects 14 through 15, wherein transmitting the indication of the timing advance value comprises: transmitting the indication of the timing advance value in an information element of a radio resource control message.

Aspect 17: The method of any of aspects 10 through 16, further comprising: transmitting, to the UE, downlink control information indicating scheduling information for the uplink message, wherein the uplink message is transmitted in accordance with the scheduling information.

Aspect 18: The method of any of aspects 10 through 17, wherein the first control message, the second control message, or both, comprises a radio resource control message or a medium access control (MAC) control element (MAC-CE).

Aspect 19: An apparatus for wireless communications, comprising a memory, and a processor coupled to the memory and configured to perform a method of any of aspects 1 through 9.

Aspect 20: An apparatus for wireless communications, comprising at least one means for performing a method of any of aspects 1 through 9.

Aspect 21: A non-transitory computer-readable medium storing code for wireless communications, the code comprising instructions executable by a processor to perform a method of any of aspects 1 through 9.

Aspect 22: An apparatus for wireless communications at a network device, comprising a memory, and a processor coupled to the memory and configured to perform a method of any of aspects 10 through 18.

Aspect 23: An apparatus for wireless communications at a network device, comprising at least one means for performing a method of any of aspects 10 through 18.

Aspect 24: A non-transitory computer-readable medium storing code for wireless communications at a network device, the code comprising instructions executable by a processor to perform a method of any of aspects 10 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
a memory; and
a processor coupled to the memory and configured to:
receive a first control message indicating a timing advance configuration for a component carrier associated with a serving cell, the timing advance configuration indicating a set of timing advance values for communications via the component carrier;
receive a second control message indicating a unified transmission configuration indicator state for an uplink message via the component carrier; and
transmit the uplink message via the component carrier in accordance with the unified transmission configuration indicator state and a timing advance value from the set of timing advance values, the timing advance value based at least in part on the unified transmission configuration indicator state.

2. The apparatus of claim 1, wherein the processor coupled to the memory is further configured to cause the apparatus to:
receive a third control message indicating an association between a set of unified transmission configuration indicator states including the unified transmission configuration indicator state and the set of timing advance values, wherein the timing advance value is identified based at least in part on the association between the unified transmission configuration indicator state and the timing advance value.

3. The apparatus of claim 1, wherein the processor coupled to the memory is further configured to cause the apparatus to:
receive a third control message indicating an association between a set of unified transmission configuration indicator groups and the set of timing advance values, wherein a unified transmission configuration indicator group of the set of unified transmission configuration indicator groups includes the unified transmission configuration indicator state, wherein the timing advance value is identified based on an association between the unified transmission configuration indicator group and the timing advance value.

4. The apparatus of claim 3, wherein, to receive the third control message, the processor coupled to the memory is further configured to cause the apparatus to:
receive a bitmap indicating the association between the set of unified transmission configuration indicator groups and the set of timing advance values.

5. The apparatus of claim 1, wherein, to receive the second control message, the processor coupled to the memory is further configured to cause the apparatus to:
receive an indication of the timing advance value for the uplink message in the second control message.

6. The apparatus of claim 5, wherein, to receive the indication of the timing advance value, the processor coupled to the memory is further configured to cause the apparatus to:
receive a timing advance group identifier that indicates the timing advance value.

7. The apparatus of claim 5, wherein, to receive the indication of the timing advance value, the processor coupled to the memory is further configured to cause the apparatus to:
receive the indication of the timing advance value in an information element of a radio resource control message.

8. The apparatus of claim 1, wherein the processor coupled to the memory is further configured to cause the apparatus to:
receive downlink control information indicating scheduling information for the uplink message, wherein the uplink message is transmitted in accordance with the scheduling information.

9. The apparatus of claim 1, wherein the first control message, the second control message, or both, comprises a radio resource control message or a medium access control (MAC) control element (MAC-CE).

10. An apparatus for wireless communications at a network device, comprising:
a memory; and
a processor coupled to the memory and configured to:
transmit, to a user equipment (UE), a first control message indicating a timing advance configuration for a component carrier associated with a serving cell configured by the network device, the timing advance configuration indicating a set of timing advance values for communications via the component carrier;
transmit, to the UE, a second control message indicating a unified transmission configuration indicator state for an uplink message via the component carrier; and
receive, from the UE, the uplink message on the component carrier in accordance with the unified transmission configuration indicator state and a timing advance value from the set of timing advance values, the timing advance value based at least in part on the unified transmission configuration indicator state.

11. The apparatus of claim 10, wherein the processor coupled to the memory is further configured to cause the apparatus to:
transmit, to the UE, a third control message indicating an association between a set of unified transmission configuration indicator states including the unified transmission configuration indicator state and the set of timing advance values, wherein the timing advance value is identified based at least in part on the association between the unified transmission configuration indicator state and the timing advance value.

12. The apparatus of claim 10, wherein the processor coupled to the memory is further configured to cause the apparatus to:
transmit, to the UE, a third control message indicating an association between a set of unified transmission configuration indicator groups and the set of timing advance values, wherein a unified transmission configuration indicator group of the set of unified transmission configuration indicator groups includes the unified transmission configuration indicator state, wherein the timing advance value is identified based on an association between the unified transmission configuration indicator group and the timing advance value.

13. The apparatus of claim 12, wherein, to transmit the third control message, the processor coupled to the memory is further configured to cause the apparatus to:
transmit a bitmap indicating the association between the set of unified transmission configuration indicator groups and the set of timing advance values.

14. The apparatus of claim 10, wherein, to transmit the second control message, the processor coupled to the memory is further configured to cause the apparatus to:
transmit an indication of the timing advance value for the uplink message in the second control message.

15. The apparatus of claim 14, wherein, to transmit the indication of the timing advance value, the processor coupled to the memory is further configured to cause the apparatus to:
transmit a timing advance group identifier that indicates the timing advance value.

16. The apparatus of claim 14, wherein, to transmit the indication of the timing advance value, the processor coupled to the memory is further configured to cause the apparatus to:
transmit the indication of the timing advance value in an information element of a radio resource control message.

17. The apparatus of claim 10, wherein the processor coupled to the memory is further configured to cause the apparatus to:
transmit, to the UE, downlink control information indicating scheduling information for the uplink message, wherein the uplink message is transmitted in accordance with the scheduling information.

18. The apparatus of claim 10, wherein the first control message, the second control message, or both, comprises a radio resource control message or a medium access control (MAC) control element (MAC-CE).

19. A method for wireless communications, comprising:
receiving a first control message indicating a timing advance configuration for a component carrier associated with a serving cell, the timing advance configuration indicating a set of timing advance values for communications via the component carrier;
receiving a second control message indicating a unified transmission configuration indicator state for an uplink message via the component carrier; and
transmitting the uplink message via the component carrier in accordance with the unified transmission configuration indicator state and a timing advance value from the set of timing advance values, the timing advance value based at least in part on the unified transmission configuration indicator state.

20. The method of claim 19, further comprising:
receiving a third control message indicating an association between a set of unified transmission configuration indicator states including the unified transmission configuration indicator state and the set of timing advance values, wherein the timing advance value is identified based at least in part on the association between the unified transmission configuration indicator state and the timing advance value.

21. The method of claim 19, further comprising:
receiving a third control message indicating an association between a set of unified transmission configuration indicator groups and the set of timing advance values, wherein a unified transmission configuration indicator group of the set of unified transmission configuration indicator groups includes the unified transmission configuration indicator state, wherein the timing advance value is identified based on an association between the unified transmission configuration indicator group and the timing advance value.

22. The method of claim 21, wherein receiving the third control message comprises:
receiving a bitmap indicating the association between the set of unified transmission configuration indicator groups and the set of timing advance values.

23. The method of claim 19, wherein receiving the second control message comprises:
receiving an indication of the timing advance value for the uplink message in the second control message.

24. The method of claim 23, wherein receiving the indication of the timing advance value comprises:
receiving a timing advance group identifier that indicates the timing advance value.

25. The method of claim 23, wherein receiving the indication of the timing advance value comprises:
receiving the indication of the timing advance value in an information element of a radio resource control message.

26. The method of claim 19, further comprising:
receiving downlink control information indicating scheduling information for the uplink message, wherein the uplink message is transmitted in accordance with the scheduling information.

27. The method of claim 19, wherein the first control message, the second control message, or both, comprises a radio resource control message or a medium access control (MAC) control element (MAC-CE).

28. A method for wireless communications at a network device, comprising:
transmitting, to a user equipment (UE), a first control message indicating a timing advance configuration for a component carrier associated with a serving cell configured by the network device, the timing advance configuration indicating a set of timing advance values for communications via the component carrier;
transmitting, to the UE, a second control message indicating a unified transmission configuration indicator state for an uplink message via the component carrier; and
receiving, from the UE, the uplink message on the component carrier in accordance with the unified transmission configuration indicator state and a timing advance value from the set of timing advance values, the timing advance value based at least in part on the unified transmission configuration indicator state.

29. The method of claim 28, further comprising:
transmitting, to the UE, a third control message indicating an association between a set of unified transmission configuration indicator states including the unified transmission configuration indicator state and the set of timing advance values, wherein the timing advance value is identified based at least in part on the association between the unified transmission configuration indicator state and the timing advance value.

30. The method of claim 28, further comprising:
transmitting, to the UE, a third control message indicating an association between a set of unified transmission configuration indicator groups and the set of timing advance values, wherein a unified transmission configuration indicator group of the set of unified transmission configuration indicator groups includes the unified transmission configuration indicator state, wherein the timing advance value is identified based on an association between the unified transmission configuration indicator group and the timing advance value.
